(19) United States
(12) Patent Application Publication
(10) Pub. No.: US 2011/0131818 A1
(43) Pub. Date: Jun. 9, 2011

(54) DEVICES FOR EXTRACTING SEMI-SOLID FOOD MATERIAL FROM CYLINDRICAL CONTAINERS

(76) Inventor: Daniel Lichty, Abbotsford (CA)

(21) Appl. No.: 12/632,367

(22) Filed: Dec. 7, 2009

(51) Int. Cl. B26B 3/00

(52) U.S. Cl. 30/299

(57) ABSTRACT

Devices for removing semi-solid food from a cylindrical container, the devices comprising an elongate shaft having an upper end portion and a lower end portion, a means for rotating the shaft, such as a handle connected to the upper end portion, and at least one curved blade member extending radially outward from the lower end portion of the shaft around its periphery.

### BACKGROUND OF THE INVENTION

1. Field of the Invention

The present invention relates to a device for removing semi-solid substances such as food material from a cylindrical container, particularly to a device for removing frozen juice in cylindrical frozen plug form from a cylindrical can.

2. Description of Related Art

The use of sealed cylindrical containers such as cans for the storing of semi-solid foods and frozen drink concentrates is well known, and is a mainstay for the storage and distribution of foods of many types. Where the food to be stored is semi-solid, as is the case with food products such as heavy creams, condensed soups, frozen juice concentrates, re-fried beans, pet foods, and the like, these substances exhibit a consistency that render them difficult to be extracted from the container thereof, at times even with the use of a kitchen utensil such as a spoon or fork. This reduces in part the convenience factor associated with a consumer's decision to purchase the containerized food in the first place. As such, from the perspective of consumer convenience, a need has long existed in the art for an improved extractor for the dispensing of semi-solid or soft foods from cylindrical containers.

### SUMMARY OF THE INVENTION

The present invention provides a device for the convenient removal of a semi-solid food substance from a cylindrical container and is particularly, but not exclusively, suited for the removal of frozen juice from a cylindrical container. In addition to the efficient removal of the substance from the container, the present invention also breaks the substance up into multiple fragments, which is often beneficial to the subsequent use of the food substance. Furthermore, some embodiments of the present invention may also be used to stir the substance if necessary.

In some aspects, the present invention provides a device for removing semi-solid food from a cylindrical container, the device comprising an elongate shaft having an upper end portion and a lower end portion, a means for rotating the shaft, such as a handle connected to the upper end portion, and at least one curved blade member extending radially outward from the lower end portion of the shaft around its periphery.

In some embodiments, the device has a plurality of curved blade members extending radially outward from the lower end portion of the shaft around its periphery. In some embodiments, the device has three curved blade members extending radially outward from the lower end portion of the shaft around its periphery.

In some embodiments, the curved blade members each include a leading edge, a trailing edge and a lateral edge. In some embodiments, the lateral edge may be straight to enable it to scrape against the inside surface of the cylindrical container without damaging said inside surface. In some embodiments, the leading edge may be beveled to provide a sharp radial cutting edge.

In some embodiments, the curved blade members may define a diameter in the range of about 2.0 to 3.0 inches. In some embodiments, the curved blade members may have a length along the shaft that is in the range of about 0.5 to 4.0 inches. In some embodiments, the curved blade members may have a length along the shaft that is in the range of about 1.0 to 3.0 inches.

In some embodiments, the handle may be generally disk shaped and it may be oriented to the shaft such that the shaft is perpendicular to the plane of the handle. In some embodiments, the handle includes a semi-elliptical top surface and a plurality of gripping members around a peripheral edge.

In other aspects, the present invention provides a device for removing semi-solid food from a cylindrical container, the device comprising an elongate shaft having an upper end portion and a lower end portion, a handle connected to the upper end portion of the shaft, and at least one helical blade member extending radially outward from the lower end portion of the shaft around its periphery and longitudinally along at least a portion of the length of the shaft. In some embodiments, the device has a plurality of helical blade members.

In the use of the device in conjunction with frozen juice concentrate packaged in a cylindrical container, the container of frozen juice may be held on its side with the open end positioned above a juice receptacle of the user's choice for catching the separated pieces of juice. The device handle may also be held on its side and the tips of the three blades are positioned within the container walls. The device is then forced into the frozen juice plug and simultaneously rotated in the direction indicated by both the handle and the blades. At any time, the device can be pulled out of the container to remove the fragments of frozen juice and allow them to fall into the receptacle below. This process continues until the desired amount of juice has been extracted and separated.

### BRIEF DESCRIPTION OF THE DRAWINGS

FIG. 1. is a side view of an embodiment of a food extractor in accordance with the present invention;

FIG. 2 is a perspective view from the side of the device shown in FIG. 1;

FIG. 3 is a top plan view of the device shown in FIG. 1;

FIG. 4 is a bottom plan view of the device shown in FIG. 1;

FIG. 5 is a perspective view from the side of another embodiment of a food extractor in accordance with the present invention;

FIG. 6 is a side view of the device shown in FIG. 5;

FIG. 7 is another embodiment of a food extractor in accordance with the present invention shown in a side view in (a) and in a bottom plan view in (b);

FIG. 8 is another embodiment of a food extractor in accordance with the present invention shown in a side view in (a) and in a bottom plan view in (b);

FIG. 9 is another embodiment of a food extractor in accordance with the present invention shown in a side view in (a) and in a bottom plan view in (b); and

FIG. 10 is perspective view of the device shown in FIG. 1 in which the lower end of the shaft is shown inserted into a cylindrical container.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

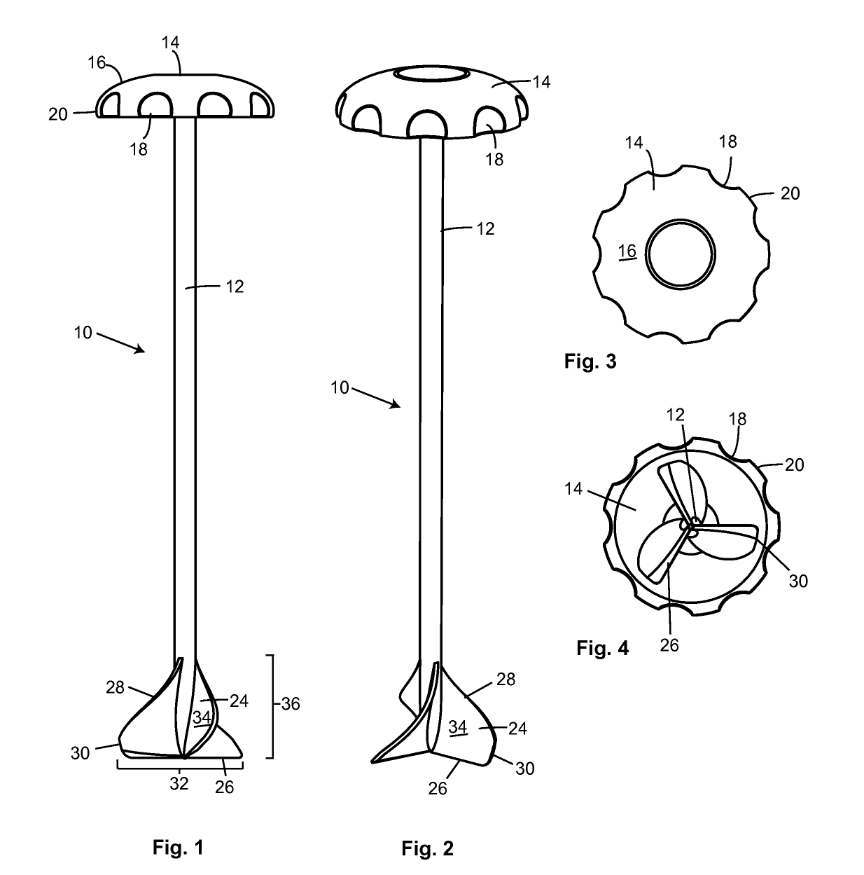

With reference to FIGS. 1 to 4, there is illustrated an embodiment of a food extractor in accordance with the present invention shown generally by reference number 10. The extractor 10 comprises an elongate shaft 12 having an upper end portion and a lower end portion opposite the upper end portion. The extractor 10 includes a means for rotating the shaft, such as a generally disk shaped handle 14 connected to the upper end portion in a manner such that the shaft 12 is perpendicular to the plane of the handle 14. The handle 14 in the illustrated embodiment includes a semi-elliptical top surface 16 to provide an ergonomic fit in the palm of a user's hand. The handle 14 includes a plurality of grip means such as indentations 18 around the periphery of the edge 20 of the handle 14 that are adapted to being engaged by the palm-side surface of a user's fingers so as to make it easier for the user to impart a rotational motion to the handle 14 and hence the shaft 12.

While this particular handle configuration has been illustrated herein, it should be noted that other handle configurations that enable a user to hold the extractor in operable orientations in one hand and to impart a rotation to the shaft are also contemplated as being within the scope of the present invention. As well, the means for rotating the shaft may comprise a motor driven mechanism connected to the shaft for rotating the shaft and which may be grasped by a user.

The lower end portion of shaft 12 includes a plurality of curved blade members 24 extending radially outward from the shaft 12 around its periphery. The blade members 24 each include a leading edge 26, a trailing edge 28 and a lateral edge 30. As used herein, the term “curved blade members” (or similar) shall mean that the blade members are curved in a manner similar to the blades on a propeller so that each blade member defines a curved face 34 that may be described as being helicoid or comprising of helicoid surfaces. The leading edge 26 may be preferably beveled to provide a sharp radial cutting edge. Preferably, the diameter 32 defined by the lateral edge 30 of rotating blade members closely conforms to the diameter of the inside of a particular cylindrical container for which the extractor 10 is intended. For example, a widely used size of cylindrical container or can that is predominant in North America at the present for canned foods and frozen juices has an inside diameter of 2⅔ inches (6.8 cm). Many pet food cans have an inside radius of 2⅝ inches (6.7 cm). Hence the diameter 32 defined by embodiments of extractors 10 that correspond to each of these commonly used container sizes would be preferably slightly (for example, 0.2 mm-10.0 mm) less than the inside diameter of the respective container. And preferably, the lateral edge 30 of each blade member may be straight and somewhat blunt to enable it to scrape against the inside surface of the cylindrical container without damaging said inside surface. This is particularly advantageous when the device is used with cardboard based cylindrical containers which could be damaged by pointy or sharp lateral edges, resulting in the cardboard material being scraped into the comestible contents.

In embodiments of the extractor 10 for use in extracting frozen juice that is in a cylindrical frozen plug form in a cylindrical can, the length of the shaft 12 may be preferably adapted to enable the extractor 10 to be also used for stirring the extracted frozen juice and water mixture in a jug in which the juice is being reconstituted. For example, juice jugs sold in North America are predominantly between 4½ inches (11.5 cm) in diameter and 9 inches (23 cm) deep. Accordingly, an embodiment of the extractor 10 for use therewith may preferably have a shaft length of 9 inches (23 cm) or longer to enable a user to use the extractor 10 for stirring the juice mixture while holding onto the handle 14 without submerging the handle in the mixture.

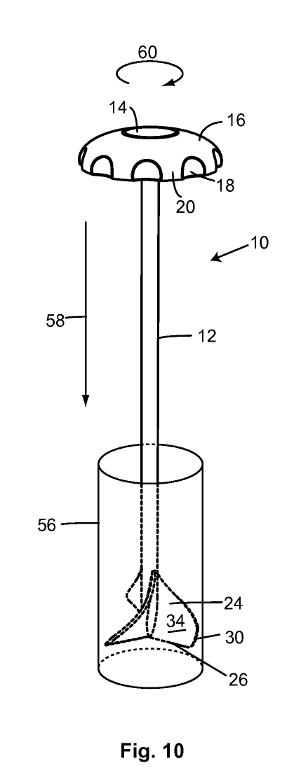

To use the extractor 10 to remove semi-solid food material from a cylindrical container, such as a can 56 as shown in FIG. 10, a user removes the lid (not shown) of the container by means of either a can opener or by means provided on the container itself. Then, while grasping the handle 14 in the palm of one hand, the user axially aligns the extractor 10 with the container and moves the extractor 10 towards the contents (not shown) of the container so that the outer edges 30 of the blade members 24 are received within the inside of the container and until the leading edge 26 of the blade members 24 come into contact with the contents. Then, while holding the opening of the container over a suitable vessel or receptacle for receiving the extracted contents, the user applies pressure against the handle 14 in direction 58 while simultaneously imparting a rotation 60 to the extractor 10 in the direction which causes the leading edge 26 of the blade members 24 to bite into the contents. The action of the blade members as they bite into the contents would typically break up the contents, and a reciprocal movement of the blade members 24 within the container at various intervals would typically clear any broken up pieces from the container. If the user desires to extract all of the contents, he or she would continue to apply pressure and rotational motion to the handle 14 (hence the blade members 24) until the leading edges 26 reach the bottom of the container. One or more reciprocal movements of the device within the container should be sufficient to extract any remaining contents from the container such that the contents fall into the vessel beneath the container opening. Advantageously, in the case of the contents being frozen juice, the extractor 10 also breaks up the frozen juice into frozen juice fragments, which more easily dissolve in water than a single plug of frozen juice during the process of reconstituting the juice. In addition, in an embodiment having a long shaft 12, the extractor serves a secondary function of stirring the juice and water mixture.

In preferred embodiments, the plurality of curved blade members comprises three curved blades (as shown in FIG. 4) as this configuration has been found to be quite effective in breaking up the food contents, and having three blade members makes it easy to locate the blade members within the inside of the cylindrical container such that the axis of the shaft 12 and the axis of the container align.

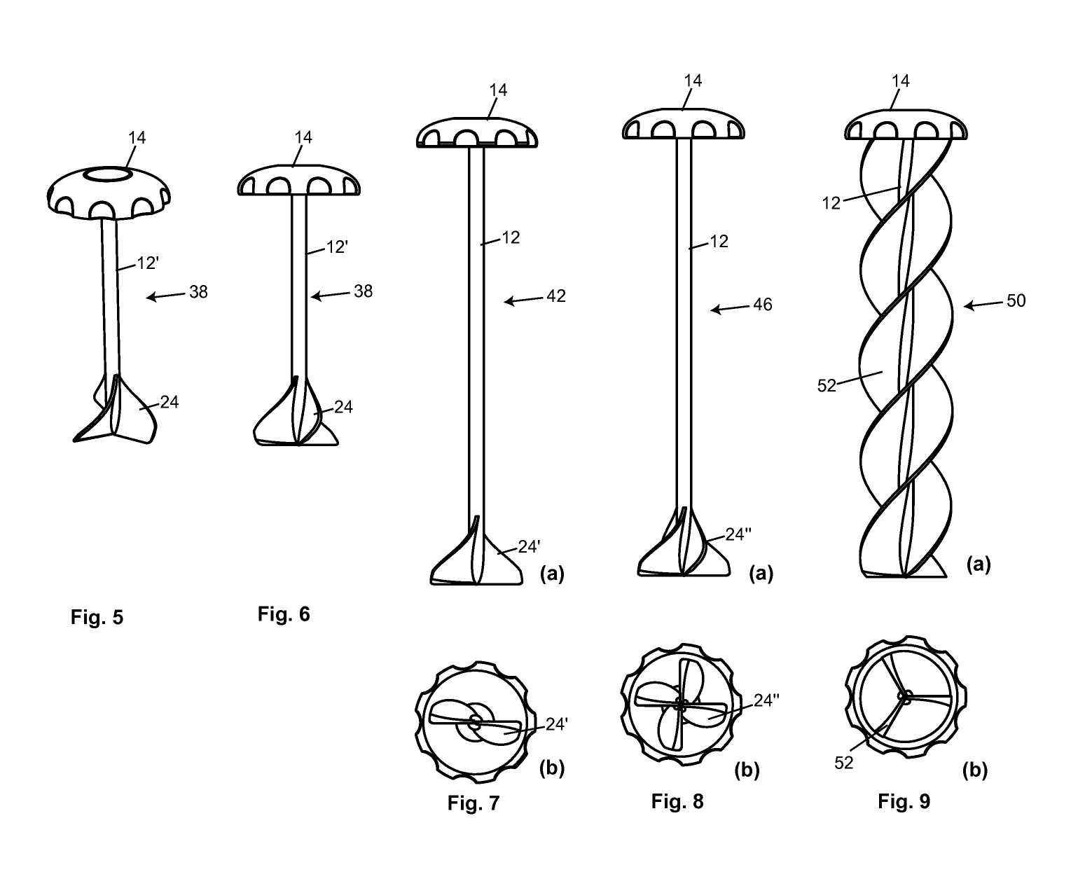

Referring to FIGS. 5 to 9, there are shown other embodiments of food extractors in accordance with the present invention.

In FIGS. 5 and 6, there is shown a food extractor 38 having a shaft 12′ that is connected to a handle 14 and a plurality of curved blade members 24 as in the extractor 10. The difference is that the shaft 12′ is shorter than the shaft 12 so that it corresponds more closely to the depth of the cylindrical containers with which it is intended to be use for extracting the container's contents.

In FIG. 7, there is shown a food extractor 42 having a shaft 12 that is connected to a handle 14 as in the extractor 10 (as shown in FIG. 7a), but which has a plurality of curved blade members 24′ comprising of two blades (as shown in FIG. 7b). A two bladed configuration will function to extract food contents from a container, but not as well as a three bladed configuration.

In FIG. 8, there is shown a food extractor 46 having a shaft 12 that is connected to a handle 14 as in the extractor 10 (as shown in FIG. 8a), but which has a plurality of curved blade members 24″ comprising of four blades (as shown in FIG. 8b). A four bladed configuration will extract food contents from a container and will tend to break the contents up into smaller pieces than a three bladed configuration. Depending on the particular intended application, this may be advantageous enough to justify the slight increase in cost of manufacture of a four bladed device over one with fewer blades.

Of course, it is contemplated that other embodiments of the food extractor of the present invention may be provided with more than four curved blades, but the increased complexity and costs of manufacturing such configurations may not be justified, and may even be detrimental to the overall performance or longevity of the device. As well, it is contemplated that a device with only one curved blade member may also be functional, though not as well as a multi-bladed device.

In preferred embodiments of the present invention, the length 36 of the curved blades or blade members along the shaft (12 or 12′) is in the range of about 0.5 to 4.0 inches (1.3 to 10.2 cm), and even more preferably in the range of about 1.0 to 3.0 inches (2.5 to 7.6 cm).

In FIG. 9, there is shown a food extractor 50 having a shaft 12 that is connected to a handle 14 as in the extractor 10, but which includes a plurality of helical blades comprising of three helical blades 52 that extend along the entire length of the shaft 12. Variants of this embodiment may have two, or more than three, helical blades 52, and each would have suitable applications. But in general, the increased complexity and costs of manufacture of embodiments having the helical blades 52 may not be justified, and may even be detrimental to the overall performance or longevity of the device. As well, it is contemplated that a device with only one helical blade member may also be functional. In these embodiments, the blade members are described as being helical because each one spirals around the shaft like a helix.

While some variants of the present invention have been described and illustrated, it is contemplated that even further variants are possible and would nevertheless fall within the scope of the present invention. For example, without limitation, the curved blade members may extend further up the shaft than illustrated in the embodiments exemplified in FIGS. 1 to 8. Likewise, the helical blade members of the embodiment exemplified by FIG. 9 may be shortened so that each extends only partially up the shaft, such as for example, one-third of the length of the shaft, one-half the length of the shaft, or further along the length of the shaft. And as stated above, other handle configurations are possible.

While the above description and illustrations constitute preferred or alternate embodiments of the present invention, it will be appreciated that numerous variations may be made without departing from the scope of the invention. It is intended that the invention be construed as including all such modifications and alterations.

What is claimed is:

1. A device for removing semi-solid food from a cylindrical container, the device comprising:
an elongate shaft having an upper end portion and a lower end portion opposite the upper end portion;
at least one curved blade member extending radially outward from the lower end portion of the shaft around its periphery; and
a means for rotating the shaft connected to the shaft.

2. The device of claim 1 wherein the means for rotating the shaft comprises a handle connected to the upper end portion of the shaft.

3. The device of claim 2 wherein the at least one curved blade member includes a leading edge, a trailing edge and a lateral edge.

4. The device of claim 2 having three curved blade members extending radially outward from the lower end portion of the shaft around its periphery.

5. The device of claim 4 wherein the curved blade members each include a leading edge, a trailing edge and a lateral edge.

6. The device of claim 5 wherein the curved blade members define a diameter in the range of about 2 to 3 inches.

7. The device of claim 5 wherein the curved blade members have a length along the shaft that is in the range of about 0.5 to 4.0 inches.

8. The device of claim 5 wherein the curved blade members have a length along the shaft that is in the range of about 1.0 to 3.0 inches.

9. The device of claim 5 wherein the lateral edge is straight to enable it to scrape against the inside surface of the cylindrical container without damaging said inside surface.

10. The device of claim 9 wherein the leading edge is beveled to provide a sharp radial cutting edge.

11. The device of claim 5 wherein the handle is generally disk shaped and is oriented to the shaft such that the shaft is perpendicular to the plane of the handle.

12. The device of claim 11 wherein the handle includes a semi-elliptical top surface and a plurality of gripping members around a peripheral edge.

13. A device for removing semi-solid food from a cylindrical container, the device comprising:
an elongate shaft having an upper end portion and a lower end portion;
a handle connected to the upper end portion of the shaft; and
at least one helical blade member extending radially outward from the lower end portion of the shaft around its periphery and longitudinally along at least a portion of the length of the shaft.

14. The device of claim 13 having a plurality of helical blade members.
